(19) United States
(12) Patent Application Publication
(10) Pub. No.: US 2007/0075601 A1
(43) Pub. Date: Apr. 5, 2007

(54) Oil-storing device used in bearing assembly in motor

(76) Inventor: Manabu Shiraki, Shanghai (CN)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/349,730

(22) Filed: Feb. 8, 2006

(30) Foreign Application Priority Data
Sep. 30, 2005 (CN) 200510030289.2

(51) Int. Cl. H02K 5/16; H02K 21/12; F04B 17/00

(52) U.S. Cl. 310/90; 417/423.12; 310/156.32

(57) ABSTRACT

The invention relates to an oil-storing device used in bearing assembly in a kind of motor including a rotor of motor and a stator of motor; the rotor includes a rotation shaft housing holding a shaft, many impellers which are settled in radial direction at proper interval along outer circumference the rotation shaft housing, magnets which are settled on the back of the rotation shaft housing; the stator includes a frame, a circular bearing receptacle shaped inside the frame, a stator subassembly and a stator subassembly base; an oil-impregnated bearing is settled inside the circular bearing receptacle; it is characterized by a nether bearing part and an upper bearing part which is joined vis-à-vis in the orientation of the rotation shaft; a hole in the nether bearing part and the upper bearing part for the rotation shaft; a concave shaped in the interlayer of the upper part and nether part of the oil-impregnated bearing respectively; an oil-storing device which is formed by the joining of the concave of the nether bearing part and the upper bearing part. An upper bearing part and a nether bearing part are arranged in the orientation of the rotation shaft according to the invention So that it is not only easy to manufacture but also easy to change the size of the concave, namely, the capacity of oil-storing, so it's useful very much.

### FIELD OF THE INVENTION

The invention relates to a kind of bearing and motor, especially to the oil-storing device used in bearing assembly in a kind of motor.

### BACKGROUND OF THE INVENTION

The existing technology published in patent application Ser. No. CN2002-34205 published the technical content as follows: it includes a rotary shaft, an oil-impregnated bearing which holds the rotation shaft and is characterized by the concave located in the inner circumference side of the oil-impregnated bearing in order to reserve oil.

Though it doesn't indicate the manufacturing method of the oil-impregnated bearing in the existing technology content of the patent application as stated above, the concave located in the inner side of the oil-impregnated bearing gives rise to the difficulty of manufacture. In addition, it is difficult to further increase the capacity of the oil-storing device and, to some extent, subjects to the dimension constraint etc.

### SUMMARY OF THE INVENTION

The purpose of the invention is to provide an oil-storing device for bearing assembly in a kind of motor. It's not only easy to manufacture bearing assembly and motor, but also easy to select the bearing and motor corresponding to the capacity demand of oil-storing device.

The purpose of the invention is realized as follows:

An oil-storing device used in bearing assembly in a kind of motor includes a rotor and a stator of motor; the rotor includes a rotation shaft housing holding a shaft, many-impellers which are settled in radial direction at proper interval along outer circumference of the rotation shaft housing, and magnets which are settled on the back of the rotation shaft housing; the stator includes a frame, a circular bearing receptacle which is shaped inside the frame, a stator subassembly and a stator subassembly base; an oil-impregnated bearing is settled inside the circular bearing receptacle;

it's characterized by:

the oil-impregnated bearing includes a nether bearing part and a upper bearing part which are joined vis-à-vis in the orientation of the rotation shaft; there is a hole in the nether bear part and the upper bearing part for the rotation shaft; a concave is shaped in the interlayer of the nether bearing part and the upper bearing part respectively; the join of the concave of the nether bearing part and the concave of the upper bearing part forms the oil-storing device.

In the oil-storing device used in bearing assembly in motor as stated above, the end opposite the interlayer of the nether part of the oil-impregnated bearing shapes the cylindric groove; an oil blocking plate which is installed in the groove is fixed on the said base; the end opposite the interlayer of the upper part of the oil-impregnated bearing shapes the cylindric groove; an oil blocking plate which is installed in the groove is fixed on the rotation shaft housing.

In the oil-storing device used in bearing assembly in motor as stated above, the cylindric bearing housing is installed outside the oil-impregnated bearing; the nether bearing part and the upper bearing part are fixed inside the bearing housing after pressing in.

In the oil-storing device used in bearing assembly in motor as stated above; the circular bearing receptacle is shaped inside the stator subassembly base; the nether bearing part and the upper bearing part are embedded in the bearing receptacle directly.

In the oil-storing device used in bearing assembly in motor as stated above; the oil-locking part which can reserve oil is installed in the oil-storing device which is formed by the joining of the concave of the nether bearing part and the concave of the upper bearing part.

In the oil-storing device used in bearing assembly in motor as stated above, electrifying the coil will rotate the rotation shaft in the function of the oil-impregnated bearing, the coil and the magnet.

In the oil-storing device used in bearing assembly in motor as stated above, electrifying the coil will rotation the rotor in the function of the oil-impregnated bearing, the coil and the magnet.

Comparing with the existing technology, the oil-storing device, because of the technology scheme adopted in the invention, has the advantages and ideal effects as follows:

1. Since including the nether bearing part and the upper bearing part which are joined vis-à-vis in the orientation of the rotation shaft of the oil-impregnated bearing and the concave formed in the interlayers of the two bearing parts respectively according the invention, oil can be stored by the concave of the nether bearing part and the concave of the upper bearing part. Obviously, it's not only easy to manufacture the concave which is shaped in the interlayers of the nether part of bearing and the upper part of bearing respectively by cutting and grinding etc., but also easy to meet the capacity demand of the oil-storing device by the way of changing the radius of the concave.

2. The invention prevents the oil leak from the interlayers because of the vertical setting of the interlayers of the nether bearing part and upper bearing part relative to the rotation shaft.

3. The invention can control the flux of oil coming from the oil-storing position and postpone the time of oil exhaustion because of the oil-locking part installed in the oil-storing device, which can reserve oil.

4. Since the oil-impregnated bearing includes the cylindric bearing housing which can fix the nether bearing part and the upper bearing part after pressing in, the invention can prevents the oil leak from the interlayers.

5. The invention decreases the quantity of parts because of the integrated structure of the stator subassembly base and the bearing receptacle which is shaped in the base holding the coil.

### BRIEF DESCRIPTION OF THE DRAWINGS

The purpose, structure characteristic and advantage of the invention can be further understood by means of description of the embodiments of the oil-storing device used in bearing parts in motor according to the invention referring to the appended drawing as follows:

FIG. 1 is the longitudinal section of the first embodiment of the oil-storing device used in bearing assembly in motor according to the invention.

FIG. 2 is the schematic perspective view of bearing portion of the first embodiment of the oil-storing device used in bearing assembly in motor according to the invention.

FIG. 3 is the longitudinal section of the second embodiment of the oil-storing device used in bearing assembly in motor according to the invention.

FIG. 4 is the schematic perspective view of bearing portion of the second embodiment of the oil-storing device used view bearing assembly in motor according to the invention.

FIG. 5 is the longitudinal section of the third embodiment of the oil-storing device used bearing assembly in motor according to the invention.

FIG. 6 is the longitudinal section of the fourth embodiment of the oil-storing device used in assembly in motor according to the invention.

FIG. 7 is the longitudinal section of a structure-changing embodiment of the oil-storing device used in bearing assembly in motor according to the invention.

### DETAILED DESCRIPTION OF THE PREFERRED EMBODIMENTS

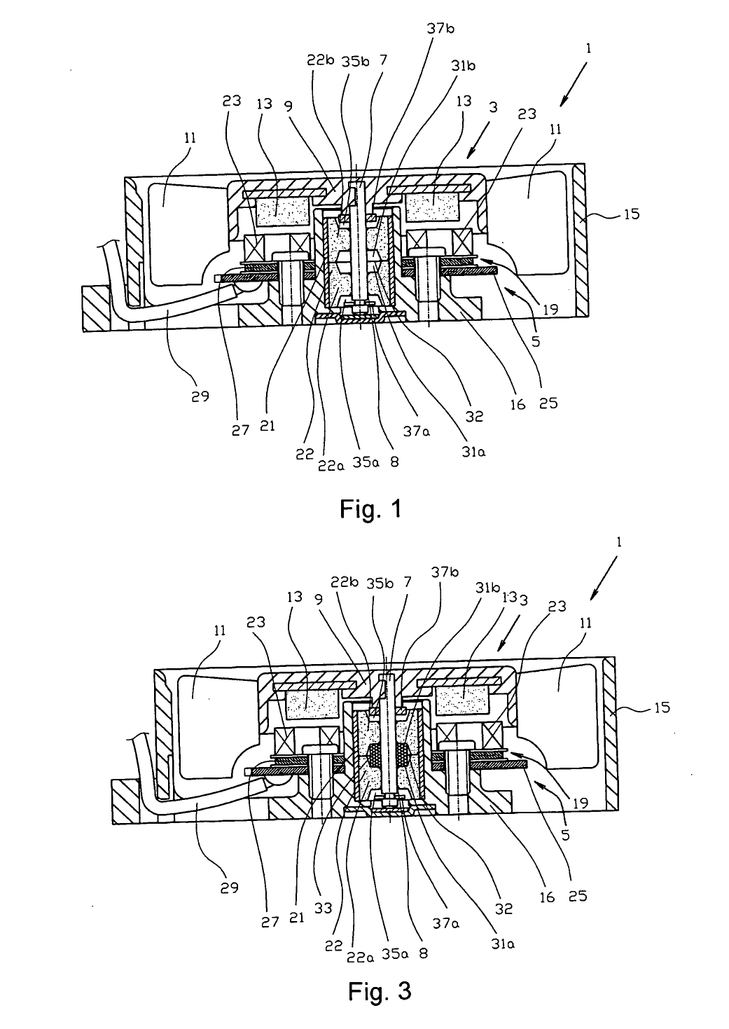

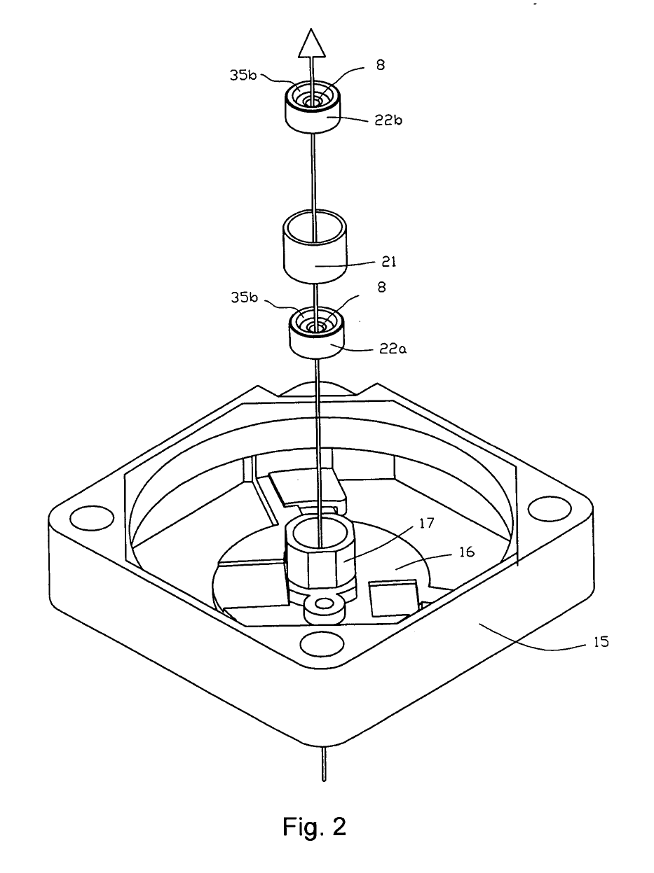

Please refer to FIG. 1 and FIG. 2; they are the schematic view of the first embodiment of the oil-storing device used in bearing assembly in motor according to the invention. In the embodiment, motor 1 comprises rotor 3 and stator 5.

Rotor 3 includes the shaft 7, the rotation shaft housing 9 holding the shaft, the many-impellers 11 which are settled in radial direction at proper interval along outer circumference of the rotation shaft housing 9 and the magnets 13 which are settled on the back of the rotation shaft housing 9. The magnets 13 are arranged into the shape of concentric circles and pole N and pole S are alternatively arranged in the circumferential direction.

Stator 5 includes the frame 15, the circular bearing receptacle 17 shaped inside the frame 15, the stator subassembly 19 and the stator subassembly base 16. The cylindric bearing housing 21 made of iron or brass etc. is embedded in the bearing receptacle 17. The oil-impregnated bearing 22 is pressed into the cylindric bearing housing 21.

The structure forming the oil-storing device in stator 5 will be particularized as follows.

The stator subassembly 19 in the stator 5 includes the coil 23, the basic plate 25 which holds the coil 23 and controls circuit, the coil yoke 27 between the basic plate 25 and the coil 23, the wire 29 installed in the orientation of toward the basic plate 25 from the outer power. If the wire 29 provides the coil 23 with current, the shaft 7 rotates because of the electromagnetic force between the coil 23 and the magnet 13.

The oil-impregnated bearing 22 in the stator 5 is made of sintering metal which is impregnated with lubricating oil. In addition, the oil-impregnated bearing 22 includes the nether part 22a and the upper part 22b of the oil-impregnated bearing which is joined vis-à-vis in the orientation of rotation shaft; and there is a hole 8 in the nether part 22a and upper part 22b of the oil-impregnated bearing for the rotary shaft 7; the concave 31a, 31b is shaped in the interlayer of the nether part 22a and upper part 22b of the oil-impregnated bearing respectively; the join of the concave 31a of the nether bearing part 22a and the concave 31b of the upper bearing part 22b forms the oil-storing device 32.

In addition, the end opposite the interlayer of the nether bearing part 22a shapes the cylindric groove 35a; the oil-blocking plate 37a which is fixed on the stator subassembly base 16 is installed in the groove 35a; after the oil passes through the clearance between the circumference of the hole 8 which is used to insert the shaft 7 and the inside circumference of the oil-impregnated bearing 22, the oil will collide with the oil-blocking plate 37a, and then, the oil returns into the groove 35a and further into the oil-impregnated bearing 22, so it's difficult to leak. Equally, the end opposite the interlayer of the upper bearing part 22b shapes the cylindric groove 35b; the oil-blocking plate 37b which is fixed on the rotary shaft housing 9 is installed in the groove 35b.

The work circumstance, function and effect of the first embodiment are as follows:

When the coil 23 is connected to the power, the electromagnetic force is generated by the magnetic field formed from the coil 23 and the magnet 13. The electromagnetic force rotates the shaft 7 and the impeller 11 at the same time, and then, wind comes into being. The oil of the oil-impregnated bearing 22, permeates between the outside circumference of the shaft 7 and the hole 8 of the oil-impregnated bearing 22, and restrains the spin friction between the outside circumference of the shaft 7 and the hole 8 of the oil-impregnated bearing 22.

In the embodiment, if the oil of the entity of the oil-impregnated bearing 22 decreases, the oil from the oil-storing device will infiltrate out, so the oil supplies the outside circumference of the shaft 7 and the hole 8 of the oil-impregnated bearing 22 smoothly in a long time.

Known from the description of the embodiment as above, the interlayer of the nether part 22a and upper part 22b of the oil-impregnated bearing shapes the concave 31 respectively, which is easy to manufacture by cutter tool and grinding machine etc., so it's easy to produce.

At the same time, the capacity of the oil-storing device can be changed as will if the size of the caliber of the concave 31, is changed.

In addition, even if the shaft 7 has eccentricity, the interlayers can't be separated each other freely and it prevents the oil leak from the interlayers because of the vertical setting of the interlayers of the nether bearing part 22a and upper bearing part 22b relative to the shaft 7.

And besides, the nether bearing part 22a and the upper bearing part 22b are fixed firmly because the nether part 22a and the upper part 22b of the oil-impregnated bearing is fixed inside the bearing housing 21, even if the shaft 7 has eccentricity, the interlayer can't be separated each other freely and it prevents the oil leak from the interlayer.

Next, the structure of other embodiments will be explained. In the embodiments as follows, the parts acting the same effect as the first embodiment will be marked by the same symbols and their particularization will be omitted. The different structure from the first embodiment will be particularized.

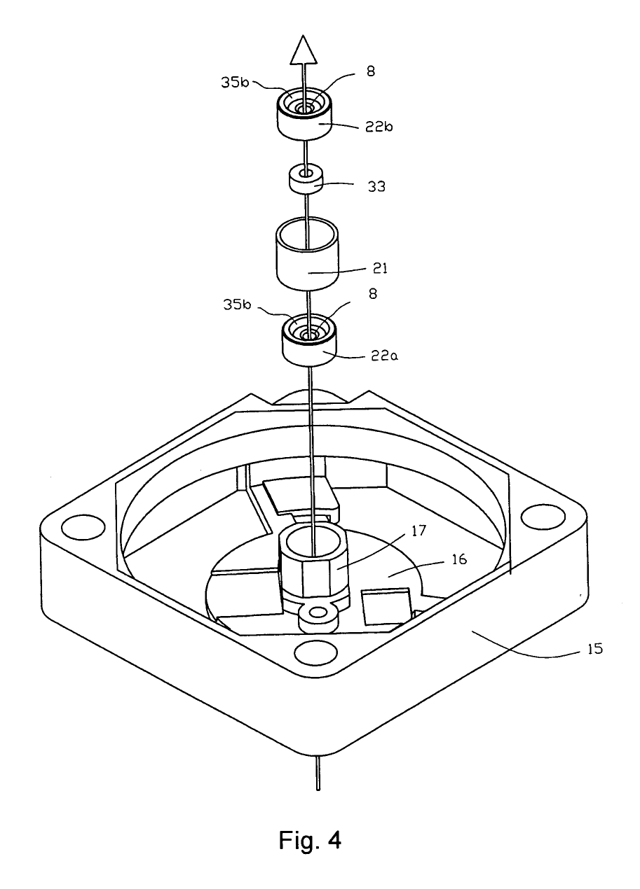

Please refer to FIG. 3 and FIG. 4; they are the schematic view of the second embodiment according to the invention. In the motor 1 of the embodiment, the oil-locking part 33 which can reserve oil is installed in the position of oil-storing. The invention adopts felt, sponge, absorbent paper as the oil-locking part 33 which can reserve and infiltrate oil.

According to FIG. 3 and FIG. 4, the oil-locking part 33 which is installed in the position of oil-storing can not only prevent oil leaking from the position of oil-storing but also postpone the time of oil exhaustion.

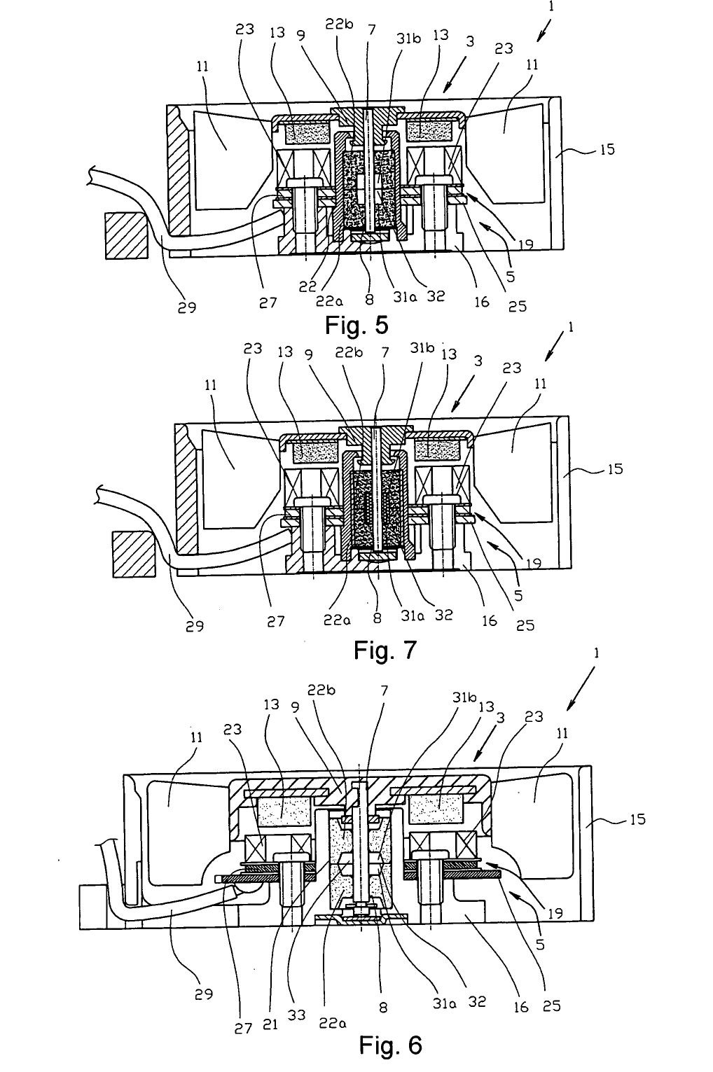

Please refer to FIG. 5; FIG. 5 is the schematic longitudinal section of the third embodiment according to the invention. In the motor 1 of the embodiment, the oil-impregnated bearing 22 is installed in the frame 15 which is made of resin.

According to FIG. 5, the oil-impregnated bearing 22 is installed in the frame 15 made of resin which is not coessential with the frame 15, so it needn't to form the bearing receptacle 17 in the frame 15, then, the forming of the frame 15 becomes easy.

Please refer to FIG. 6; FIG. 6 is the schematic longitudinal section of the fourth embodiment of the oil-storing device used in bearing assembly in motor according to the invention. In the motor 1 of the embodiment, the bearing receptacle 17 is formed inside the base 16 which holds the coil 23; the nether bearing part 22a and the upper bearing part 22b are embedded in the bearing receptacle 17 directly. In this way, the invention decreases the quantity of parts because of the integrated structure of the base and the bearing receptacle which is shaped in the base.

Of course, the invention has variety of modification in the domain of the invention besides the embodiments as above.

Please refer to FIG. 7; FIG. 7 is a schematic longitudinal section of a structure-changing embodiment of the oil-storing device used in bearing assembly in motor according to the invention. In the structure-changing of FIG. 7, the nether bearing part 22a and the upper bearing part 22b are pressed into the cylindric bearing housing 21, then the bearing housing is installed in the frame 15.

The motor in the invention may act as fun motor 1, driving motor of CD and DVD. So the motor in the invention has variety of utilities.

In conclusion, the oil-storing device used in bearing assembly in motor according to the invention, including the nether part and upper part of the oil-impregnated bearing which is joined vis-à-vis in the orientation of the rotation shaft and the concave shaped in the interlayers of the two bearing parts respectively, is not only easy to manufacture, but also easy to meet the capacity demand of oil-storing device by the way of changing the radius of the concave; at the same time, the invention prevents the oil leak from the interlayers because of the vertical setting of the interlayer of the nether bearing part and the upper bearing part relative to the rotation shaft and the cylindric bearing housing which can fix the nether part and the upper part of the oil-impregnated bearing after pressing in; in addition, the invention can control the flux of oil coming from the oil-storing position because of the oil-locking part installed in the oil-storing device, which can reserve oil; further more, the invention can decrease the quantity of parts because of the integrated structure of the stator subassembly base and the bearing receptacle which is shaped in the stator subassembly base , so it's useful very much.

What is claimed is:

1. An oil-storing device used in bearing assembly in motor which includes a rotor (3) and a stator (5) forming the motor (1);
the rotor (3) including a shaft (7), a rotation shaft housing (9) holding the shaft, many impellers (11) which are settled in radial direction at proper interval along outer circumference of the rotation shaft housing (9) and magnets (13) which are settled on the back of the rotation shaft housing (9);
the stator (5) including a frame (15), a circular bearing receptacle (17) shaped inside the frame (15), a stator subassembly (19) and a stator subassembly base (16); an oil-impregnated bearing (22) being settled inside the circular bearing receptacle (17);
being characterized by:
the oil-impregnated bearing (22) includes a nether bearing part (22a) and a upper bearing part (22b) which is joined vis-à-vis in the orientation of rotation shaft;
there is a hole (8) in the nether bearing part (22a) and the upper bearing part (22b) for the rotation shaft 7; a concave (31a, 31b) is shaped in the interlayer of the nether bearing part (22a) and the upper bearing part (22b) respectively;
the join of the concave (31a) of the nether bearing part (22a) and the concave (31b) of the upper bearing part (22b) forms an oil-storing device (32).

2. The oil-storing device used in the bearing assembly in motor as claim 1 wherein:
the end opposite the interlayer of the nether bearing part (22a) shapes a cylindric groove (35a); an oil-blocking plate (37a) which is installed in the groove (35a) is fixed on the stator subassembly base (16);
the end opposite the interlayer of the upper bearing part (22b) shapes a cylindric groove (35b); an oil-blocking plate (37b) which is installed in the groove (35b) is fixed on the rotation shaft housing (9).

3. The oil-storing device used in the bearing assembly in motor as claim 1 wherein the cylindric bearing housing (21) is installed outside the oil-impregnated bearing (22); the nether bearing part (22a) and the upper bearing part (22b) are fixed inside the bearing housing (21) after pressing in.

4. The oil-storing device used in the bearing assembly in motor as claim 1 or 3 wherein:
the circular bearing receptacle (17) is shaped inside the stator subassembly base (16); the nether bearing part (22a) and the upper bearing part (22b) are embedded in the bearing receptacle (17) directly.

5. The oil-storing device used in the bearing assembly in motor as claim 1 wherein:
an oil-locking part (33) which can reserve oil is installed in the oil-storing device (32) which is formed by the joining of the concave (31a) of the nether bearing part (22a) and the concave (31b) of the upper bearing part (22b).

6. The oil-storing device used in the bearing assembly in motor as claim 1 or 5 wherein:
electrifying the coil (23) will rotate the rotation shaft (7) in the function of the oil-impregnated bearing (22), the coil (23) and the magnet (13).

7. The oil-storing device used in the bearing assembly in motor as claim 1 or 3 wherein:
electrifying the coil (23) will rotate the rotation shaft in the function of the oil-impregnated bearing (22), the coil (23) and the magnet (13).
